(19) United States
(12) Patent Application Publication
(10) Pub. No.: US 2021/0294044 A1
(43) Pub. Date: Sep. 23, 2021

(54) APPARATUS AND METHOD FOR ALIGNING POLARIZATION-MAINTAINING OPTICAL FIBERS

(71) Applicants: Fraunhofer-Gesellschaft Zur Förderung Der Angewandten Forschung E. V., München (DE); AIXEMTEC GmbH, Herzogenrath (DE); PHIX B.V., Enschede (NL)

(72) Inventors: Sebastian Haag, Aachen (DE); Andrea Alippi, Enschede (NL); Tobias Müller, Aachen (DE); Daniel Zontar, Aachen (DE); Ronald Dekker, Enschede (NL)

(21) Appl. No.: 17/253,769

(22) PCT Filed: Jun. 14, 2019
(86) PCT No.: PCT/EP2019/065774

§ 371 Date: Dec. 18, 2020

(30) Foreign Application Priority Data
Jun. 19, 2018 (DE) 10 2018 114 741.4

(51) Int. Cl. G02B 6/38; G02B 6/255; G02B 6/024

(52) U.S. Cl. CPC G02B 6/3803; G02B 6/024; G02B 6/2555

(57) ABSTRACT

In a method for aligning a polarization-maintaining optical fiber, in which the optical fiber (7a, 7b, 7c) is held in clamping fashion by means of a clamping device (12, 19, 23), a given rotational position of the optical fiber (7a, 7b, 7c) about the fiber longitudinal axis is detected, and the optical fiber (7a, 7b, 7c) is rotated about the fiber longitudinal axis by means of the clamping device (12, 19, 23), it is proposed that at least one clamping element (13, 14, 20-22, 24-27) of the clamping device (12, 19, 23), said clamping element abutting against the optical fiber (7a, 7b, 7c), is moved relative to at least one further clamping element (13, 14, 20-22, 24-27) of the clamping device (12, 13, 17), said at least one further clamping element likewise abutting against the optical fiber (7a, 7b, 7c), for the purposes of rotating the optical fiber (7a, 7b, 7c). Moreover, a correspondingly configured apparatus is presented.

The invention relates to a method according to the preamble of claim 1 and an apparatus according to the preamble of claim 11.

In various applications, end pieces of optical fibers must be positioned or held in a specific alignment. This applies, for example, when fitting a connector with end pieces of optical fibers, optical coupling in an integrated photonic circuit or when splicing two optical fibers.

For the invention concerned here, it should be understood overall that light is also the range of electromagnetic radiation that lies outside the spectrum that is visible to the human eye.

DE 102 42 379 A1 discloses a method and an apparatus for positioning an optical fiber and for splicing two optical fibers, wherein a longitudinal section of the optical fiber perpendicular to its longitudinal direction is held in a fixed position relative to a holding element by cohesion or adhesion forces of a liquid. The liquid can be implemented, for example, in the form of a drop protruding from a pipette or a drop of liquid in a triangular groove. The optical fiber is held at a distance from the holding element by means of a clamping device which is rotated as a whole in order to cause the optical fiber to rotate about its fiber longitudinal axis.

A method and an apparatus of the type mentioned at the outset are known from DE 39 37 057 A1, the apparatus being a splicing apparatus for optical fibers. The optical fibers are each placed on a clamping apparatus for splicing, that is, material connection. Splicing should in particular also be suitable for polarization-maintaining optical fibers. The optical fibers are aligned to one another, on the one hand, in a translatory manner, so that the center points of the optical fibers to be connected are aligned with one another. On the other hand, the optical fibers must be adapted to one another with regard to their rotational position about the respective fiber longitudinal axis in order to avoid weakening the polarized radiation to be transmitted. To adapt the rotational position, at least one of the optical fibers is rotated to the required extent by means of an alignment shaft in which the optical fiber is fixed in a clamping fashion.

A method and an apparatus for determining the position of a fiber core in an optical fiber are known from DE 10 2005 020 622 A1, wherein this publication also relates essentially to the splicing of optical fibers. These can be, for example, PANDA fibers or bow-tie fibers. The rotational position of an optical fiber is determined by means of two optical systems which radiate through the optical fiber from two different directions, each perpendicular to the longitudinal axis of the optical fiber, and which analyze the structure of the radiation passing through. The determination of the rotational position is possible due to the given symmetries in the special fiber structures considered here. The optical fiber can rotate by rotating a holder that fixes the optical fiber relative to the optical systems.

A method and an apparatus of the type mentioned at the outset are also known from DE 388 88 306 T2. Optical fibers to be rotated are held in an apparatus which has at least two clamping devices which are spaced apart from one another as seen in the longitudinal direction of the optical fibers. One of the clamping devices is used to rotate the optical fiber clamped therein, wherein, for the rotation, said clamping device itself is rotated overall relative to other components of the apparatus.

According to the prior art, tool structures required to rotate the optical fibers are quite extensive. This is disadvantageous in applications in which little space is available or in which a plurality of optical fibers having a certain rotational position have to be brought tightly packed onto a fixing device, for example, a connector.

The invention is based on the technical problem of providing a method and an apparatus of the type mentioned at the outset with which manual or automated alignment and/or positioning of an optical fiber can be performed in a simplified manner with little space requirement.

The technical problem is solved with a method of the type mentioned at the outset having the characterizing features of claim 1 and with an apparatus of the type mentioned at the outset having the characterizing features of claim 11.

Advantageous embodiments of the method according to the invention and the apparatus according to the invention emerge from the dependent claims.

With regard to the method according to the invention, provision is thus made to hold the optical fiber in a clamping fashion by means of a clamping device, to detect a given rotational position of the optical fiber around the fiber longitudinal axis, and to rotate the optical fiber around the fiber longitudinal axis by means of the clamping device, with the proposed innovation that the rotation of the optical fiber is effected by moving at least one clamping element of the clamping device which abuts against the optical fiber relative to at least one further clamping element of the same clamping device which also abuts against the optical fiber.

According to the prior art, until now, rotation of the optical fiber has been achieved using a tool by which the clamping device was rotated as a whole. This procedure, which is disadvantageous due to the space requirement, is avoided in that the rotation of the optical fiber is achieved in that at least two clamping elements, which each abut against the optical fiber and are part of a tool, namely a clamping device, are moved relative to one another.

The abutment of the respective clamping element against the optical fiber means either a direct abutment against a part of the optical fiber, such as the fiber matrix or a fiber cladding or another coating, or an indirect abutment against the optical fiber, namely against an element surrounding the optical fiber, such as a cable sheath or another cover. A cable sheath or a cover can be firmly connected to the optical fiber or the clamping is carried out with sufficient strength that, due to frictional forces between the optical fiber and the cable sheath or cover, the relative movement of the abutting clamping elements effects the desired rotation of the optical fiber.

If reference is made in the following illustration and in the claims to optical fibers in interaction with the clamping elements, the variant in which the optical fiber is still surrounded by a cable cladding or another cover should also be understood as being included, as long as the illustration does not indicate the lack of the cable cladding or another cover in the region of the clamping elements.

The relative movement of the clamping elements involved can be a pure translational movement. In the simplest case, the clamping elements can be similar to the elements of a pliers head, but which can be displaced relative to one another in their longitudinal direction. The translational movement in this case should have a component perpendicular to the fiber longitudinal axis. If it is a purely translational movement, the optical fiber may perform a rolling movement on at least one of the abutting clamping elements as a consequence. As a result, the rotational movement may change not only the rotational position of the optical fiber but also the other spatial coordinates of the optical fiber, which is why a correction of these spatial coordinates by a translatory movement of the clamping device can be useful overall.

A change in the other spatial coordinates of the optical fiber could also be avoided with purely translational movement of the clamping elements relative to one another when a stationary slide bearing allowing rotation is provided on one of the clamping elements for the optical fiber and said clamping element is held stationary in its spatial coordinates.

However, the method according to the invention can also be carried out such that the relative movement is a pure rotational movement or a mixed translational and rotational movement and at least one of the clamping elements abutting against the optical fiber is a roller element rotatably mounted in the clamping device.

A pure rotational movement between the clamping elements involved can be achieved, for example, such that all the clamping elements involved are rotatably mounted roller elements against which the optical fiber abuts, for example, three roller elements arranged at the corner points of a triangle, wherein at least one of the roller elements is actively driven. A roller element can be, for example, cylindrical, barrel-shaped or conical in its circumference. Alternatively, instead of at least one of the non-actively rotationally driven clamping elements, a non-rotating clamping element having a sliding surface can be used for the optical fiber.

A mixed translational and rotational movement relative between two clamping elements of the clamping device can be achieved, for example, where, on the one hand, the optical fiber abuts against at least one rotatably mounted roller element and, on the other hand, against at least one further clamping element moved in translation relative to said at least one roller element. In addition, for example, when only one roller element is used, a clamping element having a sliding surface can be used. If the at least one roller element is held stationary in space, the optical fiber can change its rotational position with otherwise unchanged spatial coordinates.

The method according to the invention can also be carried out such that light is irradiated into the optical fiber to visualize the polarization-maintaining fiber elements and thus to detect the given rotational position of the optical fiber in relation to the guide longitudinal axis. Said light emerges at an exit facet of the optical fiber, which can be observed to determine the rotational position.

The light can be irradiated, for example, at an open end of the optical fiber facing away from the exit facet in the fiber-axial direction into an entry facet or from a lateral direction. In the case of lateral irradiation, if present at the site of the irradiation, this can also be done through a fiber cladding, a cable sheath or other covering or directly into the fiber matrix or another part of the optical fiber, given there is sufficient transparency for the irradiated light.

It can be advantageous to carry out the method according to the invention such that at an open end of the optical fiber, in particular at the exit facet, a light pattern that is dependent on the rotational position of the optical fiber and generated by the irradiated light is detected by means of a detection device. The light pattern can be sufficient for determining the optical fiber's rotational position, due to the optical fiber's structure. For example, if the optical fiber is a so-called PANDA fiber, in which two stress rods, which also guide the irradiated light, are provided in a fiber matrix in addition to a fiber core intended to conduct polarized radiation, the position of said stress rods can be seen at an open end of the optical fiber such that the rotational position of the optical fiber can be detected. If the stress rods stand out sufficiently from the fiber matrix even without light irradiation, detection of the rotational position would also be possible without light irradiation. The same applies to other structures of the optical fiber, such as bow-tie fibers or fibers having an elliptically shaped cladding (oval inner clad fiber).

The light irradiation into the entry facet can also be, for example, the irradiation of polarized light into a polarization-maintaining structure of the optical fiber, wherein the alignment of the polarization of the light exiting on the exit side is used to check the rotational position, for example, with a polarimeter as a detection device. The rotational position can also be checked by checking the coupling into another optical fiber whose rotational position is known.

The method according to the invention can also be carried out such that the light is irradiated into the optical fiber within the clamping device and/or through at least a partial region of the clamping device. A light source for this can be arranged in or on the clamping device or fixed thereto. This allows further space to be saved, since the light does not have to be irradiated in front of or behind the clamping device, as seen in the longitudinal direction of the clamped optical fiber. Depending on the arrangement of the light source, it may be necessary for the clamping device to have a sufficiently transparent region at least between the light source and the clamped optical fiber.

The light can also be irradiated through at least a partial region of the clamping device such that the light is irradiated via at least one of the clamping elements. For the coupling of the light, it can be advantageous when the refractive indices of the concerned clamping element and the material of the fiber abutting against the clamping element, for example, the fiber cladding, are identical or sufficiently similar to achieve sufficient coupling into the optical fiber for the detection of the rotational position, thus avoiding reflections in the transition area as much as possible or keeping them low. For example, in the region of entry of the light irradiated laterally into a fiber cladding made of acrylic, the concerned clamping element can be made of the same material or a material similar in terms of refraction behavior as the material of the part of the optical fiber that abuts against the clamping element. The materials can be acrylic or glass, for example. The efficiency of coupling the light from the concerned clamping element into the optical fiber can, however, also be increased by an intermediate material, for example, a liquid or a gel, having a suitable refractive index of, for example, 1.45 to 1.55, if otherwise good optical contact is problematic.

The method according to the invention can also be carried out such that the optical fiber can be held by a holding device arranged at a distance from the clamping device. In this way, on the one hand, the clamping device is at least partially relieved of any tensile forces. On the other hand, the holding device can be used to establish a reference point for the rotation of the optical fiber. For this purpose, the holding device can be a sheath fixing device which holds a cable sheath surrounding the optical fiber, wherein the cable sheath allows the optical fiber to rotate therein. However, the holding device can also hold the optical fiber freed from the cable sheath or a cable sheath that is firmly connected to the optical fiber, which therefore does not allow rotation of the optical fiber relative to the cable sheath. The mounting in this case can be so loose that the optical fiber or the cable sheath can also rotate in the holding device in the event of a rotation of the piece of the optical fiber clamped in the clamping device or can also follow another movement. Since the rotation required to correct the rotational position is usually very small, for example, at most 90°, it is not always necessary to rotate the optical fiber or the cable sheath in the holding device, so that a firm holding in the holding device is also possible.

The method according to the invention can also be carried out such that a distal end of the optical fiber is fixed with the desired rotational position in a fixing element. The fixing element can be, for example, a connector unit or a chip to which the optical fiber is fixed. The fixing element can, however, also be a further optical fiber, for example, for splicing with the first optical fiber.

For processing, it can be useful to free the distal end of the optical fiber from a fiber cladding layer, provided that processing is only required for the fiber matrix and the elements contained therein.

Furthermore, the method according to the invention can also be carried out such that the rotation of the optical fiber is controlled by means of the detected rotational position of the optical fiber. This measure supports a fully automatic alignment and/or positioning of the polarization-maintaining optical fiber.

In the following, embodiments of the method according to the invention and the apparatus according to the invention are explained with reference to figures.

Shown schematically are

FIG. 1a: an optical waveguide having a PANDA fiber,

FIG. 1b: an optical waveguide having a fiber with elliptical sheath,

FIG. 1c: an optical waveguide having a bow-tie fiber,

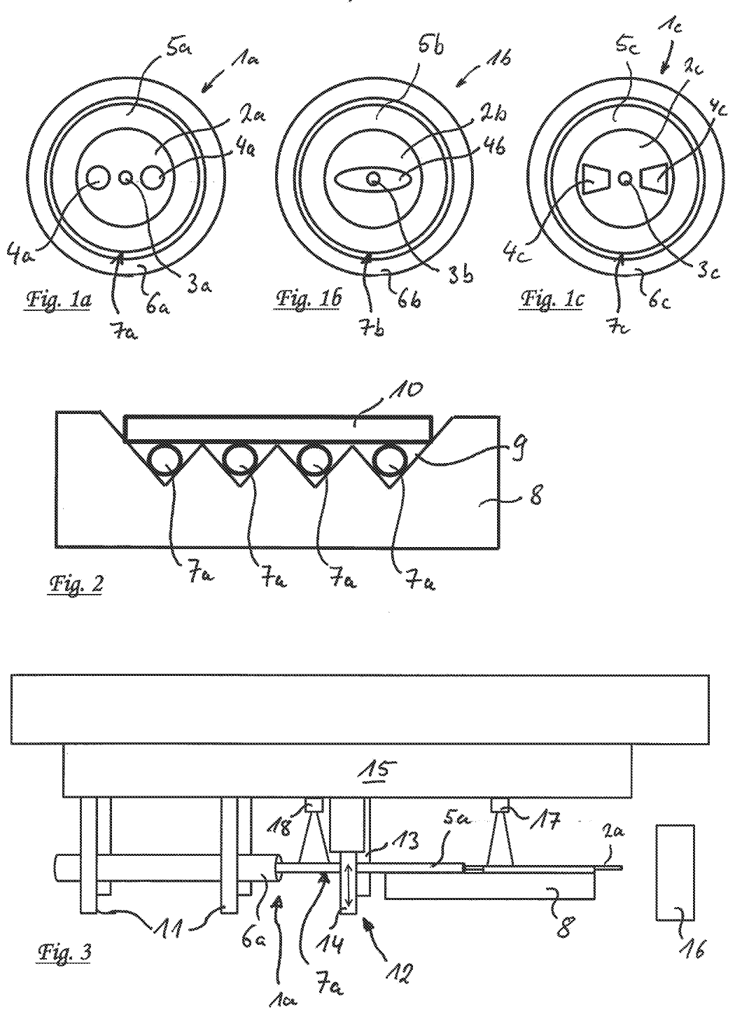

FIG. 2: a connector unit having a plurality of fibers fixed therein,

FIG. 3: an apparatus for performing the method according to the invention,

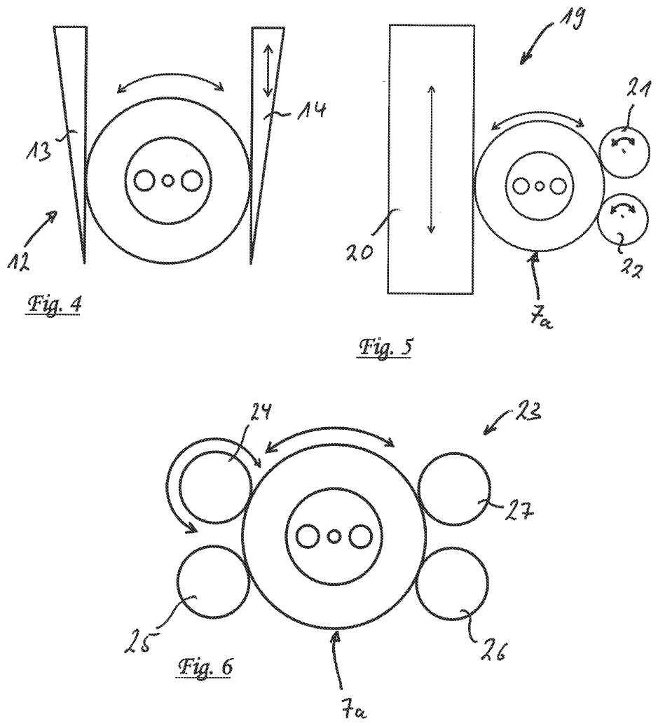

FIG. 4: a clamping device with purely translational relative movements between clamping elements,

FIG. 5: a clamping device with translational and rotational relative movements between clamping elements and

FIG. 6: a clamping device with purely rotational relative movements between clamping elements.

FIG. 1a shows schematically, in cross section, a first optical waveguide 1a having an optical fiber 7a having a structure of the so-called PANDA fiber type. The optical fiber 7a has a fiber matrix 2a surrounded by a fiber cladding 5a and an inner fiber core 3a embedded in the fiber matrix 2a, the inner fiber core being provided for forwarding polarized radiation in single mode. In addition to the fiber core 3a, two stress rods 4a generating mechanical stress are arranged in the fiber matrix 2a. The mechanical stress is material to the polarization-maintaining property of the optical fiber 7a. The optical fiber 7a is rotatably arranged in a cable sheath 6a. The representation is to be understood purely in principle and not to scale.

FIG. 1b shows, corresponding to the representation of FIG. 1a, a second optical waveguide 1b having a second optical fiber 7b having a structure of the so-called oval inner clad fiber type. The structure of the second optical waveguide 1b essentially corresponds to that of the first optical waveguide 1a according to FIG. 1a, wherein, however, no stress rods are contained in the fiber matrix 2b surrounded by the fiber cladding 5b but rather an oval inner sleeve 4b generating the desired mechanical stress surrounds the fiber core 3b. Here, a cable sheath 6b also surrounds the second optical fiber 7b.

FIG. 1c shows, corresponding to the illustration of FIG. 1a, a third optical waveguide 1c having a third optical fiber 7c having a structure of the so-called bow-tie fiber type. The structure of the third optical waveguide 1c essentially corresponds to that of the first optical waveguide 1a according to FIG. 1a, wherein however, no round stress rods are contained in the fiber matrix 2c surrounded by the fiber cladding 5c but rather stress rods 4c having the cross section of an isosceles trapezoid. A cable sheath 6c also surrounds the third optical fiber 7c here.

The aforementioned types of optical waveguides 1a, 1b and 1c are known from the prior art.

In the following, embodiments of the method according to the invention and the apparatus according to the invention are illustrated on the basis of the optical waveguide 1a having the optical fiber 7a of the PANDA fiber type. However, the embodiments apply correspondingly to other polarization-maintaining optical waveguide types, in particular also to optical waveguide types which correspond to the second optical waveguide 1b or the third optical waveguide 1c.

It is also known from the prior art, as shown in FIG. 2, to arrange a plurality of optical fibers 7a, possibly freed from the fiber cladding 5a, in a connector unit 8, wherein the optical fibers 7a have to be fixed in a defined rotational position with respect to their longitudinal axis in order to be able to pass on the polarized light in the desired orientation for further use. The optical fibers 7a can be fixed in V-shaped grooves 9 of the connector unit 8 using an adhesive (not illustrated here) and additionally or alternatively with a cover element 10. As an alternative to fixing the optical fibers 7a freed from the fiber cladding 5a in the grooves 9, for example, with direct contact between the fiber matrix wall and the groove wall, it is possible to fix the optical fibers 7a in the connector unit 8 with the fiber cladding 5a, for example, in the grooves 9, and to provide the fixation at a distance from the distal fiber end, which can then again be freed from the fiber cladding 5a.

The method according to the invention and the apparatus according to the invention can be used to be able to achieve the positioning of the optical fibers 7a in the desired rotational position as automatically as possible, an embodiment of which is represented schematically in FIG. 3.

The cable sheath 6a placed around the optical fiber 7a is fixed with a sheath fixing device 11 and thus the position of the optical fiber 7a is also largely predetermined in directions orthogonal to the fiber longitudinal axis. The optical fiber 7a of the optical waveguide 1a is held in a clamping fashion by a clamping device 12 on the fiber cladding 5a at a distal end at which the optical waveguide 1a is freed from the cable sheath 6a. The clamping device 12 is illustrated in another basic view in FIG. 4 and consists of an essentially flat first clamping element 13 and an essentially flat second clamping element 14, which are arranged on a manipulation unit 15. In order to rotate the optical fibers 7a in a defined manner about their longitudinal axis, the second clamping element 14 is moved relative to the first clamping element 13 in a translational movement, for example, downwards or upwards in FIG. 3 or 4. Since the optical fiber 7a abuts firmly against both clamping elements 13 and 14, the translational movement causes it to rotate about its longitudinal axis. Since, without further measures, the optical fiber 7a rolls away simultaneously on both clamping elements 13 and 14 with the rotational movement, the optical fiber 7a will also perform a translational movement upwards or downwards in FIGS. 3 and 4. Said translational movement of the optical fiber 7b can be compensated for by a corresponding translational movement of the entire clamping device 12.

The rotational position of the optical fiber 7a is determined using a detection device 16, which is only indicated schematically in FIG. 3. Provision can also be made for the other spatial position of the optical fiber 7a to be determined simultaneously using the detection device 16. A signal generated by the detection device 16 and dependent on the rotational position and/or other spatial position of the optical fiber 7a can be used to control the clamping device 12, for example, by using electronic data processing. If the desired rotational position of the optical fiber 7a is given, the optical fiber 7a freed from the fiber cladding 5a, that is, with the fiber matrix 2a, is inserted into one of the grooves 9 (see FIG. 2) of the connector unit 8, for example, by means of moving the clamping device 12 or by a separate movement of the connector unit 8. If a locally applied adhesive is used to fix the optical fiber 7a to the connector unit 8, it can be cured by means of a UV lamp 17.

In order to be able to better recognize the rotational position of the optical fiber 7a, light can be irradiated into the optical fiber 7a, which is passed on in particular by the stress rods 4a (see FIG. 1). The light can be irradiated laterally through the fiber cladding 5a by means of a light source 18.

FIG. 5 shows a second clamping device variant 19 having a first clamping element 20, a second clamping element 21 and a third clamping element 22, wherein the second and the third clamping element 21 and 22 are rotatably mounted in the clamping device variant 19 in a manner not illustrated here and, for example, have the shape of a cylindrical roller. If the first clamping element 20 is now moved translationally, up or down in FIG. 5, relative to the two other clamping elements 21 and 22, the optical fiber 7a clamped between the first clamping element 20 on the one hand and the second clamping element 21 and third clamping element 22 on the other hand executes a corresponding rotational movement due to the given frictional forces. Due to the rotatably mounted second and third clamping elements 21 and 22, the rotating optical fiber 7a does not execute any translational movement as long as the axes of rotation of the second and third clamping elements 21 and 22 remain fixed in space.

FIG. 6 finally shows a third clamping device variant 23 in which the optical fiber 7a is clamped between four clamping elements 24, 25, 26 and 27 rotatably mounted on the third clamping device variant 23 in a manner not illustrated here. One of the clamping elements, for example, clamping element 24, is actively driven and thus ensures a rotation of the optical fiber 7a, while the further clamping elements 25, 26 and 27 rotate with it and enable a low-wear rotation of the optical fiber 7a.

Instead of the passive, rotatably mounted clamping elements or in addition thereto, sliding surfaces are also conceivable in the clamping device variants 19 and 23, which enable the fiber 7a to rotate.

List of reference symbols

| 1a | Optical waveguide |
|---|---|
| 2a | Fiber matrix |
| 3a | Fiber core |
| 4a | Stress rod |
| 5a | Fiber cladding |
| 6a | Cable sheath |
| 7a | Optical fiber |
| 1b | Second optical waveguide |
| 2b | Fiber matrix |
| 3b | Fiber core |
| 4b | Inner sleeve |
| 5b | Fiber cladding |
| 6b | Cable sheath |
| 7b | Second optical fiber |
| 1c | Third optical waveguide |
| 2c | Fiber matrix |
| 3c | Fiber core |
| 4c | Stress rod |
| 5c | Fiber cladding |
| 6c | Cable sheath |
| 7c | Third optical fiber |
| 8 | Connector unit |
| 9 | Groove |
| 10 | Cover |
| 11 | Sheath fixing device |
| 12 | Clamping device |
| 13 | First clamping element |
| 14 | Second clamping element |
| 15 | Manipulation unit |
| 16 | Detection device |
| 17 | UV lamp |
| 18 | Light source |
| 19 | Second clamping device variant |
| 20 | First clamping element |
| 21 | Second clamping element |
| 22 | Third clamping element |
| 23 | Third clamping device variant |
| 24 | Clamping element, actively driven |
| 25 | Clamping element |
| 26 | Clamping element |
| 27 | Clamping element |

1-20. (canceled)

21. A method for aligning a polarization-maintaining optical fiber, in which
a) an optical fiber is held in a clamping fashion by means of a clamping device,
b) a given rotational position of the optical fiber around a fiber longitudinal axis is detected, and
c) the optical fiber is rotated around the fiber longitudinal axis by means of the clamping device,
characterized in that
d) for the rotation of the optical fiber, at least one clamping element of the clamping device abutting against the optical fiber is moved relative to at least one further clamping element of the clamping device also abutting against the optical fiber.

22. The method according to claim 21, characterized in that the relative movement is a pure translational movement.

23. The method according to claim 21, characterized in that the relative movement is a pure rotational movement or a mixed translational and rotational movement and at least one of the clamping elements abutting against the optical fiber is a roller element rotatably mounted in the clamping device.

24. The method according to claim 21, characterized in that light is irradiated into the optical fiber in order to detect the given rotational position of the optical fiber in relation to the fiber longitudinal axis.

25. The method according to claim 24, characterized in that at an open end of the optical fiber, a light pattern is detected which is dependent on the rotational position of the optical fiber and is generated by the irradiated light.

26. The method according to claim 24, characterized in that the light is irradiated within the clamping device and/or through at least a partial region of the clamping device into the optical fiber.

27. The method according to claim 21, characterized in that, during the rotation, a cable sheath surrounding the optical fiber and allowing rotation of the optical fiber therein is held by a sheath fixing device arranged at a distance from the clamping device.

28. The method according to claim 21, characterized in that a distal end of the optical fiber is fixed with the desired rotational position in a fixing element.

29. The method according to claim 28, characterized in that the distal end of the optical fiber is freed from a fiber cladding layer.

30. The method according to claim 21, characterized in that the rotation of the optical fiber is controlled by means of the detected rotational position of the optical fiber.

31. An apparatus for the automated alignment of a polarization-maintaining optical fiber, comprising:
a) a clamping device for gripping the optical fiber in a clamping fashion, and
b) means for rotating the optical fiber clamped in the clamping device about its fiber longitudinal axis,
characterized in that
c) the clamping device has at least two clamping elements, wherein the at least two clamping elements are provided to abut against the optical fiber for clamping and for performing the rotation of the optical fiber, the at least two clamping elements or at least two of the clamping elements are movable relative to one another.

32. The apparatus according to claim 31, characterized in that the clamping device is configured, for performing the rotation of the optical fiber, to perform a pure translational movement relative between the at least two clamping elements or between at least two of the clamping elements involved.

33. The apparatus according to claim 31, characterized in that the clamping device is configured, for performing the rotation of the optical fiber, to perform a pure rotational movement or a mixed rotational and translational movement relative between the at least two clamping elements or between at least two of the clamping elements, wherein at least one of the clamping elements involved is a roller element rotatably mounted in the clamping device.

34. The apparatus according to claim 31, characterized by a detection device for detecting the given rotational position of the optical fiber around the fiber longitudinal axis, and by irradiation means for irradiating light into the optical fiber, wherein the detection device is configured to detect the rotational position of the optical fiber based on the irradiated light.

35. The apparatus according to claim 34, characterized in that the irradiation means are configured to irradiate the light through at least a partial region of the clamping device into the optical fiber.

36. The apparatus according to claim 35, characterized in that the light is irradiated through at least one of the clamping elements into the optical fiber, wherein preferably the refractive indices of the concerned clamping elements and the material of the optical fiber abutting against the concerned clamping element are identical or at least similar to one another.

37. The apparatus according to claim 34, characterized in that at least one light source of the irradiation means is arranged or fixed in or on the clamping device.

38. The apparatus according to claim 31, characterized by a holding device spaced apart from the clamping device for holding the optical fiber.

39. The apparatus according to claim 38, characterized in that the holding device is a sheath fixing device for holding a cable sheath surrounding the optical fiber, wherein the cable sheath allows rotation of the optical fiber around its fiber longitudinal axis relative to the cable sheath.

40. The apparatus according to claim 31, characterized by means for fixing a distal end of the optical fiber in a fixing element not belonging to the apparatus.
